(19) United States
(12) Patent Application Publication
(10) Pub. No.: US 2026/0092182 A1
(43) Pub. Date: Apr. 2, 2026

(54) PRIMER COMPOSITION, MULTILAYER BODY, ARTICLE, AND METHOD FOR PRODUCING MULTILAYER BODY

(71) Applicant: DAIKIN INDUSTRIES, LTD., Osaka (JP)

(72) Inventors: Hirotake IMADA, Osaka (JP); Toshio MIYATANI, Osaka (JP); Yukari HONDA, Osaka (JP); Yasukazu NAKATANI, Osaka (JP)

(73) Assignee: DAIKIN INDUSTRIES, LTD., Osaka (JP)

(21) Appl. No.: 19/343,003

(22) Filed: Sep. 29, 2025

(30) Foreign Application Priority Data
Sep. 30, 2024 (JP) 2024-170649

(51) Int. Cl. C09D 5/00; B05D 7/22; C09D 5/03; C09D 127/18; C09D 127/20

(52) U.S. Cl. CPC C09D 5/002; B05D 7/22; C09D 5/031; C09D 5/038; C09D 127/18; C09D 127/20; B05D 2506/15

(57) ABSTRACT

Provided is a primer composition capable of curbing bubbling in a multilayer body in the case of being used to form a primer layer in the multilayer body. A primer composition for rotolining containing a powder or pellet of a perfluoropolymer and at least one predetermined powder selected from the group consisting of an amine antioxidant having a molecular weight of 1,000 or less and an organic sulfur-containing compound having a molecular weight of 1,000 or less.

### TECHNICAL FIELD

The present disclosure relates to a primer composition, a multilayer body, an article, and a method for producing a multilayer body.

### BACKGROUND ART

Rotational lining methods are known. For example, Japanese Patent Laid-Open No. 2000-237682 discloses a rotational lining method in which a powder composition containing a heat-meltable fluororesin is fed into a cylindrical article to be lined, the cylindrical article is rotated, the powder is uniformly pressed against and bonded to the article to be lined by a centrifugal force that is generated by the rotation, and the heat-meltable fluororesin is heated to be melted and made to adhere to the surface of the article to be lined. Japanese Patent Laid-Open No. 4-267744 discloses that a metal powder is mixed into a fluororesin to curb the generation of bubbles. Japanese Translation of PCT International Application Publication No. 2006-509095 discloses the use of a composition containing a non-bubble-promoting metal powder.

### SUMMARY

The present disclosure is a primer composition for rotolining comprising: a powder or pellet of a perfluoropolymer, and at least one predetermined powder selected from the group consisting of an amine antioxidant having a molecular weight of 1,000 or less and an organic sulfur-containing compound having a molecular weight of 1,000 or less.

### DESCRIPTION OF EMBODIMENTS

Hereinafter, the present disclosure will be described in detail.

### [Primer Composition]

A primer composition of the present disclosure is a composition for rotolining that is used in rotolining. In the present disclosure, rotolining means a coating method by a rotational forming.

The primer composition of the present disclosure is used for the formation of a primer layer. The primer layer is provided between a substrate and a topcoat layer and enhances adhesion between the substrate and the topcoat layer.

When an attempt is made to build a rotolined coating film from a fluororesin powder, there is a problem in that bubbling by the pyrolysis of the fluororesin occurs due to a heating treatment. Addition of a metal powder to the fluororesin powder for curbing bubbling is known. However, when the primer layer contains a metal powder, there is a problem in that bubbles remain in the multilayer body (the topcoat layer in particular). Therefore, the primer composition of the present disclosure contains at least one predetermined powder selected from the group consisting of an amine antioxidant having a molecular weight of 1,000 or less and an organic sulfur-containing compound having a molecular weight of 1,000 or less. When the primer layer contains such a predetermined powder, the problem of bubbles remaining not only in the primer layer but also in the topcoat layer can be solved. As described above, the primer composition of the present disclosure is capable of curbing bubbling in the primer layer of the multilayer body and is also capable of curbing bubbling in the topcoat layer in the case of being used for the formation of the primer layer of the multilayer body.

The primer composition of the present disclosure contains the powder or pellet of a perfluoropolymer and a predetermined powder. In the present disclosure, “predetermined powder” is defined as at least one powder selected from the group consisting of an amine antioxidant having a molecular weight of 1,000 or less and an organic sulfur-containing compound having a molecular weight of 1,000 or less. The primer composition of the present disclosure is a powdery composition, a pellet-like composition, or a mixture of a powder and pellets. Hereinafter, the perfluoropolymer and the predetermined powder that are contained in the primer composition of the present disclosure will be described.

### <Perfluoropolymer>

The perfluoropolymer that is used in the present disclosure is powdery or pellet-like. Examples of the perfluoropolymer that is used in the present disclosure include perfluoropolymers obtained by polymerizing one or more perfluoromonomers as a monomer component. Examples of the perfluoromonomers include tetrafluoroethylene [TFE], hexafluoropropylene [HFP], perfluoro(alkyl vinyl ether) [PAVE], and the like. Examples of PAVE include perfluoro(methyl vinyl ether), perfluoro(ethyl vinyl ether) [PEVE], perfluoro(propyl vinyl ether) [PPVE], and the like. The main chain of the perfluoromonomer is composed of a carbon atom, a fluorine atom, and, in some cases, an oxygen atom (for example, an ether oxygen atom) and has neither CH nor CH₂. In addition, in a case where a plurality of monomer components of the perfluoromonomer is used, the upper limit of the number of the monomer components is not limited and is, for example, ten, five, or three in some embodiments.

The perfluoropolymer that is used in the present disclosure is a polymer obtained by polymerizing the perfluoromonomer alone as a monomer component in some embodiments. The perfluoropolymer that is used in the present disclosure is also a polymer obtained by polymerizing one or more perfluoromonomers and one or more comonomers as monomer components in some embodiments. The comonomer is a monomer copolymerizable with the perfluoromonomer. Examples of the comonomer include chlorofluorovinyl monomers such as chlorotrifluoroethylene; fluorovinyl monomers such as vinylidene fluoride and trifluoroethylene; monomers having a carbonyl group-containing group; and the like. Examples of the monomers having a carbonyl group-containing group include cyclic monomers having an acid anhydride residue, monomers having a carboxy group, vinyl esters and (meth)acrylates. Examples of the cyclic monomers having an acid anhydride residue include itaconic anhydride, citraconic anhydride, 5-norbornene-2,3-dicarboxylic anhydride and maleic anhydride. In a case where the comonomer is used, the content of the comonomer is not limited as long as the perfluoromonomer is the main component and is, for example, 30 mol % or less, 10 mol % or less, 5 mol % or less, or 1 mol % or less of the total amount of the monomer components of the perfluoropolymer in some embodiments.

The perfluoropolymer is preferably a perfluoropolymer copolymerized using TFE since a coating film to be formed has high heat resistance and high chemical resistance and is suitable for protecting the substrate. For the same reasons, the perfluoropolymer is more preferably a copolymer [PFA] of TFE and PAVE, a copolymer [FEP] of TFE and HFP, or a copolymer of TFE, HFP, and PAVE. The primer composition contains one of these copolymers alone or contains two or more (for example, two or three) in some embodiments.

The perfluoropolymer copolymerized using the TFE is preferably a copolymer in which the content of a TFE unit is 75 mol % or more of the total amount of the monomer units of the perfluoropolymer, more preferably a copolymer in which the content is 85 mol % or more, still more preferably a copolymer in which the content is 90 mol % or more, and far still more preferably a copolymer in which the content is 95 mol % or more. The upper limit of the content of the TFE unit is not limited, but is, for example, 99.9 mol % or 99 mol % in some embodiments. There is a tendency that the more the TFE units, the more the heat resistance and chemical resistance of a coating film to be formed improve. On the other hand, there is a tendency that the less the TFE units, the more easily the perfluoropolymer melts, and the more the moldability improves.

The PFA is preferably a copolymer in which the mole ratio of the TFE units to the PAVE units (the TFE units/the PAVE units) is 70/30 to 99.9/0.1, more preferably a copolymer in which the mole ratio is 80/20 to 99.5/0.5, still more preferably a copolymer in which the mole ratio is 90/10 to 99/1, and far still more preferably a copolymer in which the mole ratio is 95/5 to 98.5/1.5. There is a tendency that the more the TFE units, the more the heat resistance and chemical resistance of a coating film to be formed improve. On the other hand, there is a tendency that the less the TFE units, the more easily the PFA melts, and the more the moldability improves.

The FEP is preferably a copolymer in which the mole ratio of the TFE units to the HFP units (the TFE units/the HFP units) is 70/30 to 99/1, more preferably a copolymer in which the mole ratio is 80/20 to 95/5, and still more preferably a copolymer in which the mole ratio is 85/15 to 93/7. There is a tendency that the more the TFE units, the more the heat resistance and chemical resistance of a coating film to be formed improve. On the other hand, there is a tendency that the less the TFE units, the more easily the FEP melts, and the more the moldability improves.

The copolymer of the TFE, the HFP, and the PAVE is preferably a copolymer in which the mole ratio of the total units of the TFE units and the HFP units to the PAVE units (the total units of the TFE units and the HFP units/the PAVE units) is 99.9/0.1 to 90/10 and more preferably a copolymer in which the mole ratio is 99/1 to 95/5. The mole ratio of the TFE units to the HFP units in the copolymer of the TFE, the HFP, and the PAVE is preferably the same mole ratio as the mole ratio of the TFE units to the HFP units in the FEP.

Since it is possible to maintain the amount of a component such as a thermal stabilizer in the primer layer at an appropriate amount and to sufficiently reduce the elution of the component, the content of the powder or pellet of the perfluoropolymer is preferably 85.0 mass % or more and more preferably 95.0 mass % or more of the total amount of the primer composition.

Since it is possible to sufficiently ensure the amount of the component such as the thermal stabilizer in the primer layer and to suitably curb bubbling in the primer layer, the content of the powder or pellet of the perfluoropolymer is preferably 99.5 mass % or less of the total amount of the primer composition.

Since it is easy to form a uniform primer layer that does not peel off, the average particle size of the powder or pellet of the perfluoropolymer is preferably 150 μm or more and more preferably 200 μm or more. Since it is easy to form a smooth primer layer, the average particle size of the powder or pellet of the perfluoropolymer is preferably 500 μm or less and more preferably 300 μm or less.

The average particle size of the powder or pellet of the perfluoropolymer is a value measured from an image of the primer composition observed with an electron microscope using particle analysis software. Examples of the particle analysis software include MULTIIMAGETOOL from System In Frontier Inc. The use of an element identification function of the device in such a method also makes it possible to measure the average particle size of the powder or pellet of the perfluoropolymer alone in the primer composition containing the powder or pellet of the perfluoropolymer and the predetermined powder. The average particle size is the number average value of the particle sizes of 500 randomly selected particles.

From the viewpoint of forming a smooth primer layer, the apparent density of the powder or pellet of the perfluoropolymer is preferably 0.7 g/mL or more, more preferably 0.8 g/mL or more, still more preferably 0.9 g/mL or more, far still more preferably 1.0 g/mL or more, and particularly preferably 1.1 g/mL or more. The upper limit of the apparent density of the powder or pellet of the perfluoropolymer is not limited and is, for example, 2.0 g/mL or less in some embodiments. The apparent density is measured in accordance with JIS K 6892.

The perfluoropolymer is preferably meltable. When the perfluoropolymer is meltable, it is easy to melt and process the perfluoropolymer by a heating treatment to be described below upon rotolining. The meltability of the perfluoropolymer is generally represented by the melt flow rate (MFR) as an index of flowability.

Since interlayer adhesion improves due to the flow characteristics of the perfluoropolymer, the MFR of the perfluoropolymer is preferably 0.1 g/10 minutes or more, more preferably 1 g/10 minutes or more, and still more preferably 5 g/10 minutes or more.

Since the corrosion resistance of the multilayer body improves, the MFR of the perfluoropolymer is preferably 50 g/10 minutes or less, more preferably 40 g/10 minutes or less, and still more preferably 30 g/10 minutes or less.

The MFR of the perfluoropolymer can be adjusted to be within the above-described range by, for example, adjusting the molecular weight of the perfluoropolymer. The MFR is indicated by the weight of the perfluoropolymer extruded from a nozzle with a diameter of 2 mm under a load of 5 kg for 10 minutes in accordance with ASTM D3159. The MFR is measured at 372° C. in the case of the perfluoropolymer.

Unlike a topcoat composition to be described below, the primer composition is directly applied onto the substrate, and the primer composition is thus required to be adhesive to the substrate. In order to improve the adhesiveness to the substrate of the perfluoropolymer, the perfluoropolymer preferably has a functional group that contributes to improvement in adhesiveness to the substrate. Hereinafter, the “functional group that contributes to improvement in adhesiveness to the substrate” will be referred to as the “specific functional group” in some cases. The specific functional group generates an interaction between the surface of the substrate and the perfluoropolymer and contributes to improvement in adhesiveness to the substrate. Examples of the specific functional group include functional groups shown in Table 1 below.

In order to improve the adhesiveness to the substrate of the perfluoropolymer, the perfluoropolymer preferably has 100 or more specific functional groups per 1×10⁶ main-chain carbon atoms. In order to improve the adhesiveness to the substrate of the perfluoropolymer, the perfluoropolymer preferably has 500 or less specific functional groups per 1×10⁶ main-chain carbon atoms.

Identification of the kind of specific functional group and the measurement of the number of specific functional groups can be conducted by using infrared spectroscopy.

The number of the specific functional groups is specifically measured by the following method. First, a tablet is made using the powder or pellet of the perfluoropolymer and KBr, and this tablet is analyzed by Fourier transform infrared spectroscopy. A difference spectrum between the infrared absorption spectrum of the obtained perfluoropolymer and the base spectrum in which no specific functional groups are present since the perfluoropolymer has been fully fluorinated is obtained. The number N of the specific functional groups per 1×10⁶ carbon atoms in the perfluoropolymer is calculated from the absorption peak of the specific functional group that appears in this difference spectrum according to the following formula (A).

$$N = I \times K / t \qquad ( A )$$

I: Absorbance
K: Correction coefficient
t: Thickness of film (mm)

For reference, the absorption frequencies, molar extinction coefficients, and correction coefficients of the specific functional groups in the present disclosure are shown in Table 1. The molar extinction coefficients have been determined from the FT-IR measurement data of low-molecular-weight model compounds.

TABLE 1

| | | Molar | | |
|---|---|---|---|---|
| | Absorption | extinction | | |
| Functional | frequency | coefficient | Correction | Model |
| group | (cm⁻¹) | (1/cm/mol) | coefficient | compound |
| —COF | 1883 | 600 | 388 | C₇F₁₅COF |
| —COOH | 1815 | 530 | 439 | H(CF₂)₆COOH |
| free | | | | |
| —COOH | 1779 | 530 | 439 | H(CF₂)₆COOH |
| bonded | | | | |
| —COOCH₃ | 1795 | 680 | 342 | C₇F₁₅COOCH₃ |
| —CONH₂ | 3436 | 506 | 460 | C₇H₁₅CONH₂ |
| —CH₂OH, | 3648 | 104 | 2236 | C₇H₁₅CH₂OH |
| —OH | | | | |
| —CF₂H | 3020 | 8.8 | 26485 | H(CF₂CF₂)₃CH₂OH |
| —CF═CF₂ | 1795 | 635 | 366 | CF₂═CF₂ |

The absorption frequencies of —CH₂CF₂H, —CH₂COF, —CH₂COOH, —CH₂COOCH₃, and —CH₂CONH₂ are lower than the absorption frequencies of —CF₂H, —COF, —COOH_{free}, —COOH_{bonded}, —COOCH₃, and —CONH₂ shown in Table 1 by several tens of kaisers (cm⁻¹). Therefore, for example, the number of the specific functional groups in —COF is the total of the number of the specific functional groups obtained from an absorption peak at an absorption frequency of 1,883 cm⁻¹ attributed to —CH₂COF and the number of the specific functional groups obtained from an absorption peak at an absorption frequency of 1,840 cm⁻¹ attributed to —CH₂COF.

The specific functional group is present at a main chain end or side chain end of the perfluoropolymer in some embodiments or is present in a main chain or side chain of the perfluoropolymer in some embodiments. In the present disclosure, the specific functional group is preferably present at a main chain end of the perfluoropolymer. When the specific functional group is present at a main chain end, it is possible to efficiently improve the adhesiveness to the substrate. The number of the specific functional groups is the total number of —CF═CF₂, —CF₂H, —COF, —COOH, —COOCH₃, —CONH₂, and CH₂OH in some embodiments.

In the present disclosure, the specific functional group is preferably a carbonyl group-containing group. The specific functional group is more preferably at least one group selected from the group consisting of a carbonylamide group, a carboxy group, an acylfluoride group, and a methoxycarbonyl group. From the viewpoint of imparting adhesiveness, the specific functional group is particularly preferably a carboxy group or a carbonylamide group.

The specific functional group is introduced into the perfluoropolymer by, for example, a chain transfer agent and/or a polymerization initiator used at the time of producing the perfluoropolymer. For example, in a case where an alcohol is used as the chain transfer agent, and in a case where a peroxide having a —CH₂OH structure is used as the polymerization initiator, —CH₂OH is introduced into a main chain end of the perfluoropolymer. In addition, the specific functional group is introduced into the perfluoropolymer by polymerizing a monomer having the specific functional group in some embodiments.

The specific functional group is preferably a specific functional group introduced into a perfluoropolymer end by the chain transfer agent and/or the polymerization initiator used at the time of producing the perfluoropolymer. The perfluoropolymer having such a structure is more favorable in adhesiveness to the substrate.

The specific functional group is a specific functional group that is converted into a different structure by further performing a reaction on the specific functional group introduced into the perfluoropolymer end by the chain transfer agent and/or the polymerization initiator used at the time of producing the perfluoropolymer in some embodiments. Alternatively, a method may be employed involving performing corona treatment on the powder or pellet of the perfluoropolymer to generate the functional group at a main chain end.

A method for producing the perfluoropolymer that is used in the primer composition of the present disclosure is not limited, and it is possible to appropriately select, for example, a known polymerization method such as suspension polymerization. The obtained perfluoropolymer can be crushed or formed by a known method as necessary into a powder shape or a pellet shape.

### <Predetermined Powder>

The predetermined powder functions as, for example, a thermal stabilizer, and thereby curbs bubbling in a multilayer body that can be caused by the perfluoropolymer becoming unstable due to a heating treatment in rotolining. The predetermined powder is composed of at least one powder selected from the group consisting of an amine antioxidant having a molecular weight of 1,000 or less and an organic sulfur-containing compound having a molecular weight of 1,000 or less. The upper limit of the number of types of the predetermined powders is not particularly limited, and the predetermined powder is composed of one or more and five or less powders or one or two powders in some embodiments.

In order to curb bubbling in the primer layer of the multilayer body, the content of the predetermined powder is preferably 0.1 mass % or more of the total amount of the primer composition. In order to curb bubbling not only in the primer layer but also in the topcoat layer of the multilayer body, the content of the predetermined powder is more preferably 0.5 mass % or more of the total amount of the primer composition. In order to sufficiently reduce the elution of a component of the primer layer, the content of the predetermined powder is preferably 15.0 mass % or less and more preferably 5.0 mass % or less of the total amount of the primer composition. In a case where the predetermined powder is composed of a plurality of powders, the content of the predetermined powder is the total content of the plurality of powders.

### (Amine Antioxidant)

The amine antioxidant that is used in the primer composition of the present disclosure is powdery. In the present disclosure, the amine antioxidant means an antioxidant having a structure represented by a chemical formula “—NH—.” The amine antioxidant has a sulfur atom in the molecule in some embodiments. The amine antioxidant has a molecular weight of 1,000 or less. When the molecular weight of the amine antioxidant is 1,000 or less, bubbling in the multilayer body can be suitably curbed. The lower limit of the molecular weight of the amine antioxidant is not limited and is, for example, 100 or more. The molecular weight of the amine antioxidant can be obtained from the molecular formula of the amine antioxidant.

Examples of the amine antioxidant having a molecular weight of 1,000 or less include aromatic amines having an aromatic hydrocarbon group, such as a phenyl group or a naphthyl group, in the molecule. Specific examples of the amine antioxidant having a molecular weight of 1,000 or less include phenylenediamine compounds such as N,N′-diphenyl-p-phenylenediamine, N,N′-di-2-naphthyl-p-phenylenediamine, and reaction products between diphenylamine and diisobutylene; aromatic secondary amine compounds such as dinaphthylamine, phenyl-α-naphthylamine, phenyl-β-naphthylamine, 4,4′-bis(α,α′-dimethylbenzyl)diphenylamine, phenylcyclohexyl-p-phenylenediamine, and styrenated diphenylamine; diphenylamine compounds such as p-(p-toluenesulfonamide)diphenylamine; benzotriazole compounds such as benzotriazole, 2-(2-hydroxy-5-methylphenyl)benzotriazole, and 2-(2-hydroxy-5-tetraoctylphenyl)benzotriazole.

Since bubbling in the multilayer body can be suitably curbed, the amine antioxidant having a molecular weight of 1,000 or less is preferably a phenylenediamine compound and a diphenylamine compound and more preferably N,N′-di-2-naphthyl-p-phenylenediamine and p-(p-toluenesulfonamide)diphenylamine.

As the amine antioxidant having a molecular weight of 1,000 or less, a commercially available product is used in some embodiments. Examples of such a commercially available product include NOCRAC White manufactured by Ouchi Shinko Chemical Industrial Co., Ltd., and NOCRAC TD manufactured by Ouchi Shinko Chemical Industrial Co., Ltd.

### (Organic Sulfur-Containing Compound)

The organic sulfur-containing compound that is used in the primer composition of the present disclosure is powdery. The organic sulfur-containing compound has a molecular weight of 1,000 or less. When the molecular weight of the organic sulfur-containing compound is 1,000 or less, bubbling in the multilayer body can be suitably curbed. The lower limit of the molecular weight of the organic sulfur-containing compound is not limited and is, for example, 100 or more. The molecular weight of the organic sulfur-containing compound can be obtained from the molecular formula of the organic sulfur-containing compound. Amine antioxidants having a sulfur atom have been exemplified in the above-described amine antioxidant section. In the present disclosure, the organic sulfur-containing compound is defined as a compound excluding amine antioxidants having a sulfur atom.

Specific examples of the organic sulfur-containing compound having a molecular weight of 1,000 or less include mercaptobenzimidazole compounds such as 2-mercaptobenzimidazole and 2-mercaptomethylbenzimidazole; mercaptobenzothiazole compounds such as 2-mercaptobenzothiazole, cyclohexylamine salts of 2-mercaptobenzothiazole, dibenzothiazyl disulfide, 2-(N,N′-diethylthiocarbamoylthio)benzothiazole, 2-(4′-morpholinodithio)benzothiazole, N-cyclohexyl-2-benzothiazolylsulfenamide, N-oxydiethylene-2-benzothiazolylsulfenamide, N-tert-butyl-2-benzothiazolylsulfenamide, N,N′-dicyclohexyl-2-benzothiazolylsulfenamide, and N,N′-diisopropylbenzothiazole-2-sulfene; mercaptoimidazoline compounds such as 2-mercaptoimidazoline; dithiocarbamic acids such as pentamethylenedithiocarbamic acid, pipecolyldithiocarbamic acid, dimethyldithiocarbamic acid, diethyldithiocarbamic acid, dibutyldithiocarbamic acid, and N-ethyl-N-phenyldithiocarbamic acid; thiourea derivatives such as thiourea, N,N′-diethylthiourea, N,N′-dibutylthiourea, dilaurylthiourea, and N,N′-diphenylthiourea; and thiuram compounds such as tetramethylthiuram monosulfide, tetramethylthiuram disulfide, tetraethylthiuram disulfide, tetrabutylthiuram disulfide, and dipentamethylenethiuram tetrasulfide. These organic sulfur-containing compounds are, for example, metal salts of Zn, Sn, Cd, Cu, Fe, or the like; or organic salts, such as a piperidine salt and a pipecolyl salt, in some embodiments.

Since bubbling in the multilayer body can be suitably curbed, the organic sulfur-containing compound having a molecular weight of 1,000 or less is preferably a mercaptobenzothiazole compound, a metal salt thereof, and an organic salt thereof and more preferably a zinc salt of 2-mercaptobenzothiazole.

As the organic sulfur-containing compound having a molecular weight of 1,000 or less, a commercially available product is used in some embodiments. Examples of such a commercially available product include NOCCELER MZ manufactured by Ouchi Shinko Chemical Industrial Co., Ltd.

### <Other Primer Components>

The primer composition of the present disclosure contains only the perfluoropolymer and the predetermined powder in some embodiments. In some embodiments, the primer composition of the present disclosure further contains components other than the perfluoropolymer and the predetermined powder (hereinafter referred to as the other primer components in some cases) as necessary to an extent that the effect of the present disclosure is not impaired. The other primer components are not limited, and components that are used in primers for general paints can be used. Examples of the other primer components include pigments, anti-aging agents, leveling agents, solid lubricants, moisture absorbers, surface conditioners, UV absorbers, light stabilizers, plasticizers, anti-color separation agents, anti-scratch agents, antifungal agents, antibacterial agents, antioxidants, antistatic agents, and silane coupling agents. In order to curb coating film shrinkage, the primer composition also contains a filler as the other primer component in some embodiments. The other primer components are added in a state of being independent from the perfluoropolymer in some embodiments or added in a state of having been integrated with the perfluoropolymer, for example, by being kneaded with perfluoropolymer in some embodiments. In the case of using the other primer components, the content of the other primer components is preferably 5 mass % or less, more preferably 3 mass % or less, still more preferably 2 mass % or less, and far still more preferably 1 mass % or less of the total amount of the primer composition.

In order to curb bubbling in the multilayer body, the primer composition of the present disclosure preferably contains no thermal stabilizers other than the predetermined powder. Examples of the thermal stabilizers other than the predetermined powder include metal powders to be described below.

In order to curb bubbling in the topcoat layer of the multilayer body, the primer composition of the present disclosure preferably contains no metal powders. Examples of metals that are used in the metal powders include pure metals such as Mn, Fe, Ni, Co, Cu, Zn, Mo, Pd, Ag, Cd, Sn, and Ba; alloys such as Zn/Cu (brass) and Cu/Sn (bronze); and metal oxides such as CuO.

In order to curb bubbling in the primer layer of the multilayer body, the primer composition of the present disclosure preferably contains no binder resins. Examples of the binder resins include nitrogen-containing polymers such as polyamide, polyimide, polyamide-imide, and polyetherimide; sulfur-containing polymers such as polyphenylene sulfide, polyarylene sulfide, and polyethersulfone; polyether ether ketone; and polyphenylene carbonate. The nitrogen-containing polymers are, for example, polymers containing either or both of an amide bond and an imide bond. When the primer composition contains no binder resins having a different melting point from the perfluoropolymer, at the time of the heating treatment in rotolining, it is possible to sufficiently reduce uneven melting of the primer composition and to easily form a uniform primer layer.

### <Method for Producing Primer Composition>

The primer composition of the present disclosure is produced by, for example, mixing the raw materials by a known method or the like. For example, when the perfluoropolymer, the predetermined powder, and the other primer components that are added as necessary are mixed together using a mixer, the primer composition can be produced. The mixer is not limited, and it is possible to use, for example, a V-type blender, a Henschel mixer, and the like. The predetermined powder is added in a state of being independent from the perfluoropolymer in some embodiments or added in a state of having been integrated with the perfluoropolymer, for example, by being kneaded with the perfluoropolymer in some embodiments.

### [Multilayer Body]

The present disclosure is also a multilayer body (multilayer structure) including a first layer that is a rotolined coating film formed of the above-described primer composition of the present disclosure. The multilayer body of the present disclosure includes the first layer and a second layer. The first layer is a layer on the substrate side. The multilayer body of the present disclosure further includes a substrate in some embodiments. In a case where the multilayer body includes a substrate, the first layer is provided on the substrate. The second layer is provided on the first layer. Hereinafter, the “first layer” will be referred to as the “primer layer,” and the “second layer” will be referred to as the “topcoat layer” in some cases. The primer layer is disposed closer to the substrate than the topcoat layer.

The primer composition of the present disclosure curbs bubbling in the multilayer body and also has excellent adhesiveness to the substrate. Therefore, it is preferable that a primer layer that is a rotolined coating film formed of the primer composition of the present disclosure be directly provided on the substrate.

### <Substrate>

The substrate is not limited, and examples thereof include pure metals such as iron, aluminum, copper, and nickel; alloys such as stainless steel (SUS); and non-metallic inorganic materials such as enamel, glass, and ceramics. The shape of the substrate is not limited and is, for example, tubular. In the case of a tubular substrate, a resin coating film can be easily formed on the inside of the substrate by rotolining while the tubular substrate is rotated.

### <Primer Layer>

The primer layer is a rotolined coating film formed of the above-described primer composition of the present disclosure. The thickness of the primer layer is selected as appropriate in consideration of the difficulty in peeling off the primer layer from the substrate or the like in some embodiments. From the viewpoint of uniformly forming the primer layer and the viewpoint of improving the corrosion resistance and chemical resistance of the multilayer body, the thickness of the primer layer is preferably 100 μm or more, more preferably 300 μm or more, and still more preferably 500 μm. From the viewpoint of making the substrate and the primer layer favorably adhere together to curb the peeling of the primer layer from the substrate, the thickness of the primer layer is preferably 10,000 μm or less, more preferably 8,000 μm or less, still more preferably 6,000 μm or less, far still more preferably 3,000 μm or less, and particularly preferably 1,500 μm or less. The thickness of the primer layer is measured using a magnetic type/eddy current-type film thickness meter.

Since it is possible to maintain the amount of the component, such as the thermal stabilizer, that is contained in the primer layer at an appropriate amount and to reduce the elution of the component, the content of the powder or pellet of the perfluoropolymer in the primer layer is preferably 85.0 mass % or more and more preferably 95.0 mass % or more of the total amount of the primer layer. Since it is possible to sufficiently ensure the amount of the component, such as the thermal stabilizer, that is contained in the primer layer and to suitably curb bubbling in the primer layer, the content of the powder or pellet of the perfluoropolymer in the primer layer is preferably 99.5 mass % or less of the total amount of the primer layer.

### <Topcoat Layer>

The topcoat layer is, for example, a rotolined coating film formed of a topcoat composition. The thickness of the topcoat layer is selected as appropriate in consideration of the application or the like in some embodiments. From the viewpoint of uniformly forming the topcoat layer and the viewpoint of improving the corrosion resistance and chemical resistance of the multilayer body, the thickness of the topcoat layer is preferably 100 μm or more, more preferably 300 μm or more, still more preferably 500 μm or more, far still more preferably 1,000 μm or more, and particularly preferably more than 1,500 μm. In order to obtain favorable physical properties, the thickness of the topcoat layer is preferably 10,000 μm or less, more preferably 8,000 μm or less, still more preferably 6,000 μm or less, and far still more preferably 3,000 μm or less. The thickness of the topcoat layer is measured using a magnetic type/eddy current-type film thickness meter.

The topcoat composition is not limited and is, for example, a powder composition containing a fluororesin. The topcoat composition suitably contains the powder or pellet of a perfluoropolymer. Examples of the perfluoropolymer that is used in the topcoat composition include the same perfluoropolymers as the perfluoropolymers that can be used in the primer layer. The topcoat layer is preferably a rotolined coating film formed of the powder or pellet of the perfluoropolymer.

The powder or pellet of the perfluoropolymer that is contained in the topcoat composition is different from the powder or pellet of the perfluoropolymer that is contained in the primer composition in some embodiments. However, in order to make the primer layer and the topcoat layer favorable adhere together, the powder or pellet of the perfluoropolymer that is contained in the topcoat composition is preferably the same as the powder or pellet of the perfluoropolymer that is contained in the primer composition.

The topcoat composition contains the perfluoropolymer alone. In some embodiments, the topcoat composition further contains components other than the perfluoropolymer (hereinafter referred to as the other topcoat components in some cases) as necessary to an extent that the effect of the present disclosure is not impaired. Examples of the other topcoat components include the same components as the other primer components. The topcoat composition contains either or both of an inorganic filler and carbon black to an extent that the chemical resistance and corrosion resistance of the multilayer body are not impaired.

In order to sufficiently reduce the elution of the other topcoat components, the content of the perfluoropolymer in the topcoat layer is preferably 99 mass % or more, more preferably more than 99.5 mass %, still more preferably 99.6 mass % or more, far still more preferably 99.7 mass % or more, even far still more preferably 99.8 mass % or more, by far more preferably 99.9 mass % or more, particularly preferably 99.99 mass % or more, and most preferably 99.999 mass % or more of the total amount of the topcoat layer. The upper limit of the content of the perfluoropolymer in the topcoat layer is 100.0 mass % of the total amount of the topcoat layer.

The topcoat composition and the topcoat layer formed of the topcoat composition preferably contain no thermal stabilizers. For example, there is a method in which bubbling in the multilayer body is curbed by adding a thermal stabilizer to a topcoat layer formed by rotolining. However, since the primer composition of the present disclosure is capable of curbing bubbling in the multilayer body, even in a case where the topcoat layer contains no thermal stabilizers, bubbling in the multilayer body can be suitably curbed. In addition, since the topcoat layer contains no thermal stabilizers, an advantage of making it possible to reduce coloring of the coating film due to a thermal stabilizer and an advantage of no elution of a thermal stabilizer component can also be obtained. Examples of the thermal stabilizers include amine antioxidants, organic sulfur-containing compounds, and metal powders. Examples of the amine antioxidants include the same amine antioxidants as those exemplified as the amine antioxidant having a molecular weight of 1,000 or less that is used in the primer composition. Examples of the organic sulfur-containing compounds include the same organic sulfur-containing compounds as those exemplified as the organic sulfur-containing compound having a molecular weight of 1,000 or less that is used in the primer composition. Examples of the metal powders include the same metal powders as those exemplified as the metal powders that the primer composition preferably does not contain. In order to sufficiently reduce the amount of the other topcoat components eluted, the topcoat composition and the topcoat layer formed of the topcoat composition preferably do not contain the predetermined powder.

In order to sufficiently reduce the amount of the other topcoat components eluted, the topcoat composition and the topcoat layer formed of the topcoat composition preferably do not contain at least one of a binder resin, a filler, and an inorganic powder. Examples of the binder resin include the same binder resins as those exemplified as the binder resins that the primer composition preferably does not contain. Examples of the filler include glass fibers and the like. Examples of the inorganic powder include glass powder, and silicon powder.

The topcoat composition and the topcoat layer formed of the topcoat composition preferably contain no pigments. For example, there is a method in which the color tone of a coating film derived from a thermal stabilizer is adjusted by adding a pigment to a topcoat layer formed by rotolining. However, since the primer composition of the present disclosure is capable of curbing bubbling in the multilayer body, it is possible to omit addition of a thermal stabilizer to the topcoat layer, and furthermore, it is also possible to omit addition of a pigment thereto. Since the topcoat layer contains no pigments, an advantage of no elution of a pigment component can be obtained.

### <Method for Producing Multilayer Body>

The present disclosure is also a method for producing the above-described multilayer body of the present disclosure. The method for producing a multilayer body of the present disclosure includes a first layer formation step and a second layer formation step.

### (First Layer Formation Step)

In the first layer formation step, a primer layer is formed on a substrate. In the first layer formation step, a primer layer is formed from the above-described primer composition of the present disclosure by rotolining. More specifically, the primer composition of the present disclosure is placed in a tubular substrate, and the primer composition in the substrate is heated (for example, fired) while the substrate is rotated to form a primer layer on the inner surface of the substrate. In order to melt the perfluoropolymer contained in the primer composition and perform favorable processing thereon, the heating temperature in the step is preferably 250° C. to 400° C. For the same reason, the heating time is preferably 10 to 300 minutes.

### (Second Layer Formation Step)

In the second layer formation step, a topcoat layer is formed on the primer layer. In the second layer formation step, a topcoat layer is formed from, for example, the topcoat composition by rotolining. More specifically, the topcoat composition is placed in the tubular substrate having the primer layer formed therein, and the topcoat composition in the substrate is heated while the tubular substrate is rotated to form a topcoat layer on the primer layer (more specifically, on a surface of the primer layer on the side that does not adhere to the substrate). In order to melt the topcoat composition and perform favorable processing thereon, the heating temperature in the step is preferably 250° C. to 400° C. For the same reason, the heating time is preferably 10 to 300 minutes.

### [Article]

The present disclosure is also an article having the above-described multilayer body. The article is not limited, and examples thereof include chemical solution containers, tanks, plumbing lines, joints, valves, pipes, and ducts. The article of the present disclosure is particularly suitably used in fields where the elution of a component that is contained in the primer layer and the topcoat layer is not desired. Examples of such fields include semiconductor production fields such as semiconductor production devices, semiconductor chemical solution production devices, and semiconductor chemical solution containers; medical fields such as pharmaceutical production devices and pharmaceutical containers; chemical fields such as chemical production devices and chemical containers; food fields such as alcohol brewing containers, fermented food brewing containers, and fermented food storage containers; and steel production fields such as steel plants.

the present disclosure provides a primer composition capable of curbing bubbling in a multilayer body in the case of being used for the formation of a primer layer of the multilayer body.

The present disclosure is a primer composition for rotolining comprising: a powder or pellet of a perfluoropolymer, and at least one predetermined powder selected from the group consisting of an amine antioxidant having a molecular weight of 1,000 or less and an organic sulfur-containing compound having a molecular weight of 1,000 or less.

The perfluoropolymer is preferably a copolymer of tetrafluoroethylene and perfluoro(alkyl vinyl ether), a copolymer of tetrafluoroethylene and hexafluoropropylene, or a copolymer of tetrafluoroethylene, hexafluoropropylene, and perfluoro(alkyl vinyl ether).

The content of the powder or pellet of the perfluoropolymer is preferably 95.0 mass % or more and 99.5 mass % or less of the total amount of the primer composition.

The content of the predetermined powder is preferably 0.5 mass % or more and 5.0 mass % or less of the total amount of the primer composition.

The powder or pellet of the perfluoropolymer preferably has an average particle size of 150 μm or more and 500 μm or less.

The powder or pellet of the perfluoropolymer preferably has an apparent density of 0.7 g/mL or more.

The primer composition preferably contains no metal powders.

The primer composition preferably contains neither a nitrogen-containing polymer nor a sulfur-containing polymer.

It is preferable that the perfluoropolymer is a copolymer of tetrafluoroethylene and perfluoro(alkyl vinyl ether), a copolymer of tetrafluoroethylene and hexafluoropropylene, or a copolymer of tetrafluoroethylene, hexafluoropropylene, and perfluoro(alkyl vinyl ether),
the content of the powder or pellet of the perfluoropolymer is 95.0 mass % or more and 99.5 mass % or less of the total amount of the primer composition,
the amine antioxidant is a phenylenediamine compound or a diphenylamine compound,
the organic sulfur-containing compound is a mercaptobenzothiazole compound or a metal salt thereof, and
the content of the predetermined powder is 0.5 mass % or more and 5.0 mass % or less of the total amount of the primer composition.

The present disclosure is a multilayer body comprising: a first layer that is a layer on a substrate side; and a second layer provided on the first layer, wherein the first layer is a rotolined coating film formed of the primer composition.

The second layer is a rotolined coating film formed of the powder or pellet of the perfluoropolymer, and the second layer preferably does not contain an amine antioxidant, an organic sulfur-containing compound, and a metal powder.

The second layer is a rotolined coating film formed of the powder or pellet of the perfluoropolymer, and the content of the perfluoropolymer in the second layer is preferably 99 mass % or more of the total amount of the second layer.

The first layer preferably has a thickness of 300 μm or more.

The present disclosure is an article having the multilayer body.

The present disclosure is a method for producing a multilayer body, comprising: a first layer formation step of forming a first layer on a substrate; and a second layer formation step of forming a second layer on the first layer, wherein in the first layer formation step, the first layer is formed from the above-described primer composition by rotolining.

In the second layer formation step, the second layer is preferably formed by rotolining.

The primer composition of the present disclosure is capable of curbing bubbling in a multilayer body in the case of being used for the formation of a primer layer of the multilayer body.

Hitherto, the embodiments of the present disclosure have been described, but it is understood that diverse modifications are possible in the embodiments and details without departing from the purport and scope of the claims.

### Examples

Hereinafter, the present disclosure will be specifically described by showing Examples, but the present disclosure is not limited to Examples. In the following Examples, unless particularly described, “parts” and “%” represent “parts by mass” and “mass %,” respectively.

Components that will be used in the following Examples are as described below.

Perfluoropolymer A: TFE/PEVE=95/5 mol % (MFR: 8 g/10 min., average particle size: 162 μm, apparent density: 1.0 g/mL, the number of specific functional groups per 1×10⁶ main-chain carbon atoms: 245)

Perfluoropolymer B: TFE/PPVE=98/2 mol % (MFR: 6 g/10 min., average particle size: 213 μm, apparent density: 1.1 g/mL, the number of specific functional groups per 1×10⁶ main-chain carbon atoms: 211)

Perfluoropolymer C: TFE/HFP=91/9 mol % (MFR: 5 g/10 min., average particle size: 246 om, apparent density: 0.7 g/mL, the number of specific functional groups per 1×10⁶ main-chain carbon atoms: 147)

Perfluoropolymer D: TFE/HFP/PPVE=85/13/2 mol % (MFR: 10 g/10 min., average particle size: 151 μm, apparent density: 0.8 g/mL, the number of specific functional groups per 1×10⁶ main-chain carbon atoms: 314)

Amine antioxidant P: NOCRAC White manufactured by Ouchi Shinko Chemical Industrial Co., Ltd. (compound name: N,N′-di-2-naphthyl-p-phenylenediamine, molecular weight: 360)

Organic sulfur-containing compound: NOCCELER MZ manufactured by Ouchi Shinko Chemical Industrial Co., Ltd. (compound name: zinc salt of 2-mercaptobenzothizole, molecular weight: 397)

Amine antioxidant Q: NOCRAC TD manufactured by Ouchi Shinko Chemical Industrial Co., Ltd. (compound name: p-(p-toluenesulfonylamido)diphenylamine, molecular weight: 338)

Metal powder R: Zinc powder manufactured by Kishida Chemical Co., Ltd.

Metal powder S: Iron powder manufactured by Kishida Chemical Co., Ltd.

Polyamide-imide: TORLON PAI manufactured by Solvay S.A.

Polyphenylene sulfide: RYTON PPS manufactured by Solvay S.A.

### [Preparation of Primer Compositions]

Raw material powders were mixed together in compositions shown in Table 2 to Table 5, and primer compositions of Examples 1 to 23 and Comparative Examples 1 to 9 were obtained.

### [Formation of Primer Layer]

A blast treatment was performed on the inner surface of a metal mold having an internal volume of 1 L using an alumina powder (TOSA EMERY #40 manufactured by Ujiden Chemical Industry Co., Ltd.) at a spraying pressure of 1.0 MPa. Each of the primer compositions shown in Table 2 to Table 5 was encapsulated in the blast-treated metal mold as much as a target film thickness shown in Table 2 to Table 5 could be obtained and heated using a rotolining machine at 380° C. for 60 minutes. A primer layer was formed on the inner surface of the metal mold as described above.

### [Formation of Topcoat Layer]

A topcoat composition was encapsulated in the metal mold in which the primer layer had been formed as much as a film thickness of 2,000 μm could be obtained and heated using the rotolining machine at 350° C. for 90 minutes. A topcoat layer was formed on the primer layer formed on the inner surface of the metal mold as described above, and a rotolined multilayer body was obtained. As the topcoat composition, AC-5820 (pure PFA powder) manufactured by Daikin Industries, Ltd. or AC-5830 (a mixture of a PFA powder, an amine antioxidant, and an organic sulfur-containing compound) manufactured by Daikin Industries, Ltd. shown in Table 2 to Table 5 was used.

### [Evaluation Methods]

### <Adhesiveness of Primer Layer>

After the formation of the primer layer and before the formation of the topcoat layer, the primer layer formed on the inner surface of the metal mold was observed, and the presence or absence of bubbling in the primer layer and the presence or absence of the peeling (coating film peeling) of the primer layer were observed. The adhesiveness between the primer layer and the metal mold was evaluated from the following viewpoints. “Bubbling occurs” and “B” were determined to be a fail, and “A” was determined to be a pass.

Bubbling occurs: Bubbling occurs in the primer layer

B: The coating film partially peels off

A: Coating film peeling is not observed

### <State of Rotolined Multilayer Body>

The appearances of the rotolined multilayer bodys obtained above (more specifically, the appearances of the topcoat layers) were observed and evaluated from the following viewpoints. “C” and “B” were determined to be a fail, and “A” was determined to be a pass.

C: Bubbling occurs many times in the rotolined multilayer body

B: Bubbling occurs slightly in the rotolined multilayer body

A: No bubbling occurs in the rotolined multilayer body

<Amounts of Substances Extracted from Rotolined Multilayer Body>

Among the rotolined multilayer bodys obtained above, for three rotolined multilayer bodys (rotolined multilayer bodys formed using the primer compositions of Example 5, Example 6, and Example 15) as typical examples, the amounts of substances extracted were measured. A 3.5% HCl aqueous solution was fed into containers of the three rotolined multilayer bodys and left to stand at 25° C. for seven days. After that, the total of the extractions of 17 elements (Ag, Al, Ca, Cd, Co, Cr, Cu, Fe, K, Li, Mg, Mn, Na, Ni, Pb, Ti, and Zn) was measured by inductively coupled plasma emission spectrometry. These amounts of substances extracted correspond to the amounts of components eluted mainly from the primer layers and the topcoat layers.

The evaluation results are shown in Table 2 to Table 5. “-” in the primer composition columns in Table 2 to Table 5 indicates that the corresponding components are not added. “-” in the topcoat composition columns and the rotolined multilayer body state columns in Table 2 to Table 5 indicates that no topcoat layers are formed since bubbling is observed in the primer layers. “-” in the columns of amount of substance extracted from rotolined multilayer body in Table 2 to Table 5 indicates that the extracted substance is not measured.

TABLE 2

| | | Comparative | Comparative | Comparative | Comparative | | | | |
|---|---|---|---|---|---|---|---|---|---|
| | | Example 1 | Example 2 | Example 3 | Example 4 | Example 1 | Example 2 | Example 3 | Example 4 |
| Primer | Perfluoropolymer A | 100 | — | — | — | 99 | 97 | 99 | 97 |
| composition | Perfluoropolymer B | — | 100 | — | — | — | — | — | — |
| (parts) | Perfluoropolymer C | — | — | 100 | — | — | — | — | — |
| | Perfluoropolymer D | — | — | — | 100 | — | — | — | — |
| | Amine antioxidant P | — | — | — | — | 1 | 3 | — | — |
| | Organic sulfur- | — | — | — | — | — | — | 1 | 3 |
| | containing compound | | | | | | | | |
| | Amine antioxidant Q | — | — | — | — | — | — | — | — |
| | Metal powder R | — | — | — | — | — | — | — | — |
| | Metal powder S | — | — | — | — | — | — | — | — |
| | Polyamide-imide | — | — | — | — | — | — | — | — |
| | Polyphenylene sulfide | — | — | — | — | — | — | — | — |

| | | | | | | | | |
|---|---|---|---|---|---|---|---|---|
| Target film thickness of primer | 1,000 | 1,000 | 1,000 | 1,000 | 1,000 | 1,000 | 1,000 | 1,000 |
| layer (μm) | | | | | | | | |
| Adhesiveness of primer layer | Bubbling | Bubbling | Bubbling | Bubbling | A | A | A | A |
| | occurs | occurs | occurs | occurs | | | | |
| Topcoat composition | — | — | — | — | AC 5820 | AC 5820 | AC 5820 | AC 5820 |
| Rotolined multilayer body state | — | — | — | — | A | A | A | A |
| Amount of substance extracted from | — | — | — | — | — | — | — | — |
| rotolined multilayer body (ppb) | | | | | | | | |

TABLE 3

| | | Example 5 | Example 6 | Example 7 | Example 8 | Example 9 | Example 10 | Example 11 | Example 12 |
|---|---|---|---|---|---|---|---|---|---|
| Primer | Perfluoropolymer A | — | — | — | — | — | — | — | — |
| composition | Perfluoropolymer B | 99 | 99 | 99 | 97 | 99 | 97 | 99 | 97 |
| (parts) | Perfluoropolymer C | — | — | — | — | — | — | — | — |
| | Perfluoropolymer D | — | — | — | — | — | — | — | — |
| | Amine antioxidant P | 1 | 1 | 1 | 3 | — | — | — | — |
| | Organic sulfur- | — | — | — | — | 1 | 3 | — | — |
| | containing compound | | | | | | | | |
| | Amine antioxidant Q | — | — | — | — | — | — | 1 | 3 |
| | Metal powder R | — | — | — | — | — | — | — | — |
| | Metal powder S | — | — | — | — | — | — | — | — |
| | Polyamide-imide | — | — | — | — | — | — | — | — |
| | Polyphenylene sulfide | — | — | — | — | — | — | — | — |

| | | | | | | | | |
|---|---|---|---|---|---|---|---|---|
| Target film thickness of primer layer (μm) | 1,000 | 1,000 | 1500 | 1,000 | 1,000 | 1,000 | 1,000 | 1,000 |
| Adhesiveness of primer layer | A | A | A | A | A | A | A | A |
| Topcoat composition | AC 5820 | AC 5830 | AC 5820 | AC 5820 | AC 5820 | AC 5820 | AC 5820 | AC 5820 |
| Rotolined multilayer body state | A | A | A | A | A | A | A | A |
| Amount of substance extracted from rotolined | 1.1 | 9.7 | — | — | — | — | — | — |
| multilayer body (ppb) | | | | | | | | |

TABLE 4

| | | Exam- | Exam- | Exam- | Comparative | Comparative | Comparative | Comparative | Exam- |
|---|---|---|---|---|---|---|---|---|---|
| | | ple 13 | ple 14 | ple 15 | Example 5 | Example 6 | Example 7 | Example 8 | ple 16 |
| Primer | Perfluoropolymer A | — | — | — | — | — | — | — | — |
| composition | Perfluoropolymer B | 99 | 97 | 90 | 99 | 97 | 99 | 97 | — |
| (parts) | Perfluoropolymer C | — | — | — | — | — | — | — | 99 |
| | Perfluoropolymer D | — | — | — | — | — | — | — | — |
| | Amine antioxidant P | 0.5 | 1.5 | 3 | — | — | — | — | 1 |
| | Organic sulfur- | 0.5 | — | — | — | — | — | — | — |
| | containing | | | | | | | | |
| | compound | | | | | | | | |
| | Amine antioxidant Q | — | 1.5 | 3 | — | — | — | — | — |
| | Metal powder R | — | — | — | 0.1 | 1 | — | — | — |
| | Metal powder S | — | — | — | — | — | 0.1 | 1 | — |
| | Polyamide-imide | — | — | — | — | — | — | — | — |
| | Polyphenylene sulfide | — | — | — | — | — | — | — | — |

| | | | | | | | | |
|---|---|---|---|---|---|---|---|---|
| Target film thickness of primer | 1,000 | 1,000 | 1,000 | 1,000 | 1,000 | 1,000 | 1,000 | 1,000 |
| layer (μm) | | | | | | | | |
| Adhesiveness of primer layer | A | A | A | A | A | A | A | A |
| Topcoat composition | AC 5820 | AC 5820 | AC 5820 | AC 5820 | AC 5820 | AC 5820 | AC 5820 | AC 5820 |
| Rotolined multilayer body state | A | A | A | B | B | B | B | A |
| Amount of substance extracted from | — | — | 2.7 | — | — | — | — | — |
| rotolined multilayer body (ppb) | | | | | | | | |

TABLE 5

| | | Exam- | Exam- | Exam- | Exam- | Exam- | Exam- | Exam- | Comparative |
|---|---|---|---|---|---|---|---|---|---|
| | | ple 17 | ple 18 | ple 19 | ple 20 | ple 21 | ple 22 | ple 23 | Example 9 |
| Primer | Perfluoropolymer A | — | — | — | — | — | — | — | — |
| composition | Perfluoropolymer B | — | — | — | — | — | — | — | 80 |
| (parts) | Perfluoropolymer C | 97 | 99 | 97 | — | — | — | — | — |
| | Perfluoropolymer D | — | — | — | 99 | 97 | 99 | 97 | — |
| | Amine antioxidant P | 3 | — | — | 1 | 3 | — | — | — |
| | Organic sulfur- | — | 1 | 3 | — | — | 1 | 3 | — |
| | containing | | | | | | | | |
| | compound | | | | | | | | |
| | Amine antioxidant Q | — | — | — | — | — | — | — | — |
| | Metal powder R | — | — | — | — | — | — | — | — |
| | Metal powder S | — | — | — | — | — | — | — | — |
| | Polyamide-imide | — | — | — | — | — | — | — | 12 |
| | Polyphenylene sulfide | — | — | — | — | — | — | — | 8 |

| | | | | | | | | |
|---|---|---|---|---|---|---|---|---|
| Target film thickness of primer | 1,000 | 1,000 | 1,000 | 1,000 | 1,000 | 1,000 | 1,000 | 1,000 |
| layer (μm) | | | | | | | | |
| Adhesiveness of primer layer | A | A | A | A | A | A | A | Bubbling |
| | | | | | | | | occurs |
| Topcoat composition | AC 5820 | AC 5820 | AC 5820 | AC 5820 | AC 5820 | AC 5820 | AC 5820 | — |
| Rotolined multilayer body state | A | A | A | A | A | A | A | — |
| Amount of substance extracted from | — | — | — | — | — | — | — | — |
| rotolined multilayer body (ppb) | | | | | | | | |

The evaluation results clearly demonstrate that the primer composition of the present disclosure is capable of curbing bubbling in a multilayer body in the case of being used to form a primer layer in the multilayer body.

### INDUSTRIAL APPLICABILITY

The primer composition of the present disclosure can be suitably used as a primer at the time of performing the coating of a fluororesin by rotolining.

1. A primer composition for rotolining comprising:
a powder or pellet of a perfluoropolymer; and
at least one predetermined powder selected from the group consisting of an amine antioxidant having a molecular weight of 1,000 or less and an organic sulfur-containing compound having a molecular weight of 1,000 or less.

2. The primer composition according to claim 1, wherein the perfluoropolymer is a copolymer of tetrafluoroethylene and perfluoro(alkyl vinyl ether), a copolymer of tetrafluoroethylene and hexafluoropropylene, or a copolymer of tetrafluoroethylene, hexafluoropropylene, and perfluoro(alkyl vinyl ether).

3. The primer composition according to claim 1, wherein a content of the powder or pellet of the perfluoropolymer is 95.0 mass % or more and 99.5 mass % or less of a total amount of the primer composition.

4. The primer composition according to claim 1, wherein a content of the predetermined powder is 0.5 mass % or more and 5.0 mass % or less of a total amount of the primer composition.

5. The primer composition according to claim 1, wherein the powder or pellet of the perfluoropolymer has an average particle size of 150 μm or more and 500 μm or less.

6. The primer composition according to claim 1, wherein the powder or pellet of the perfluoropolymer has an apparent density of 0.7 g/mL or more.

7. The primer composition according to claim 1, wherein a metal powder is not contained.

8. The primer composition according to claim 1, wherein neither a nitrogen-containing polymer nor a sulfur-containing polymer is contained.

9. The primer composition according to claim 1, wherein the perfluoropolymer is a copolymer of tetrafluoroethylene and perfluoro(alkyl vinyl ether), a copolymer of tetrafluoroethylene and hexafluoropropylene, or a copolymer of tetrafluoroethylene, hexafluoropropylene, and perfluoro(alkyl vinyl ether),
a content of the powder or pellet of the perfluoropolymer is 95.0 mass % or more and 99.5 mass % or less of the total amount of the primer composition,
the amine antioxidant is a phenylenediamine compound or a diphenylamine compound,
the organic sulfur-containing compound is a mercaptobenzothiazole compound or a metal salt thereof, and
a content of the predetermined powder is 0.5 mass % or more and 5.0 mass % or less of the total amount of the primer composition.

10. A multilayer body comprising:
a first layer that is a layer on a substrate side; and
a second layer provided on the first layer,
wherein the first layer is a rotolined coating film formed of the primer composition according to claim 1.

11. The multilayer body according to claim 10, wherein the second layer is a rotolined coating film formed of the powder or pellet of the perfluoropolymer, and the second layer does not contain an amine antioxidant, an organic sulfur-containing compound, and a metal powder.

12. The multilayer body according to claim 10, wherein the second layer is a rotolined coating film formed of the powder or pellet of the perfluoropolymer, and a content of the perfluoropolymer in the second layer is 99 mass % or more of a total amount of the second layer.

13. The multilayer body according to claim 10, wherein the first layer has a thickness of 300 μm or more.

14. An article comprising:
the multilayer body according to claim 10.

15. A method for producing a multilayer body, comprising:
forming a first layer on a substrate; and
forming a second layer on the first layer,
wherein in forming the first layer, the first layer is formed from the primer composition according to claim 1 by rotolining.

16. The method for producing a multilayer body according to claim 15, wherein in forming the second layer, the second layer is formed by rotolining.
